(19) United States
(12) Patent Application Publication
(10) Pub. No.: US 2008/0130029 A1
(43) Pub. Date: Jun. 5, 2008

(54) IMAGE FORMING APPARATUS AND METHOD OF CONTROLLING IMAGE FORMING APPARATUS

(75) Inventor: Tomonori Hayashi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/944,398

(22) Filed: Nov. 21, 2007

(30) Foreign Application Priority Data
Dec. 5, 2006 (JP) 2006-328523

(51) Int. Cl. G06F 15/00

(52) U.S. Cl. 358/1.9

(57) ABSTRACT

Provided is an image forming apparatus capable of enhancing ease of operation for setting information on a print process. The image forming apparatus scans a paper document, compares and collates a paper fingerprint with image data by using the paper fingerprint as a search key, and thereby outputs a printed matter processed according to settings such as interleaving. The image forming apparatus includes means that stores the paper fingerprint and the image data in association with each other, and thus, during printing, the apparatus can perform image forming processing as set, utilizing this associated information.

### BACKGROUND OF THE INVENTION

1. Field of the Invention

The present invention relates to an image forming apparatus capable of handling paper fingerprint information, a method and a program of controlling an image forming apparatus, and a storage medium having the control program stored thereon.

2. Description of the Related Art

There has been heretofore known an image forming apparatus allowing various settings on a print process to be made, the various settings including finishing settings such as stapling and punching, and settings of resolution, magnification, the amount of margin, the amount of binding margin, and a front cover, interleaving paper and a back cover.

Proposed in Japanese Patent Laid-Open No. 2004-338180 is an apparatus that reduces time and effort required for the print process, by previously printing setting information on the print process as a bar code or the like on a printing medium (e.g., a postcard, etc.) and by performing printing after reading the printed setting information.

Further, it is known that making these settings settable page by page enables print settings having a higher degree of flexibility. For example, setting for printing of ten pages of an original to be printed can be such that colored paper is inserted as interleaving paper (or partition paper) between the second and fourth pages, can be such that the third to the fifth pages are printed in color while the remaining pages are printed in monochrome, or can be otherwise.

These settings can be made by the press of keys on an operation panel provided on the body of the image forming apparatus. This enables users to freely make desired print settings.

A general image forming apparatus (e.g., a digital copying machine) is configured so that various print settings such as the insert position of interleaving paper, paper to be fed, and color/monochrome print mode selection can be made by the press of the keys on the operation panel provided on the body of the copying machine.

However, the following problem arises: it takes a great deal of time and effort for users who are unaccustomed to such key operation, to perform print setting operation for designating how a page is desired.

For example, when various print settings can be made page by page or over a range of plural pages, a method of allowing a user to select and set a page number for print settings is utilized as a setting method using the operation panel.

In this case, however, the user cannot select a page for print settings while looking at the print contents of an original to be printed, and hence the user has to memorize the page number for print settings by grasping in advance the contents of the original.

Also utilized as another example is a method that involves temporarily storing the original to be printed as image data in a storage unit in the image forming apparatus, and displaying the stored image data on the operation panel. Then, in this method, a user checks the contents of the displayed image data page by page, and thereby selects a page for print settings.

This method enables the user to select the page for print settings while looking at the print contents page by page.

However, the relatively small operation panel of the image forming apparatus is used to perform a setting process by scrolling a screen or by performing switching a display screen in order to display a next page. Thus, the above method is inferior in a total image at a glance and accessibility to the method using a paper document for the same operation. Therefore, the following problem arises: the user feels stress when performing operation for changing settings, and performing print settings takes a great deal of time and effort.

Furthermore, the above-mentioned related background art has the inconvenience of having to previously print setting information, because of being configured to acquire the print setting information from the printing medium having the print setting information printed thereon.

### SUMMARY OF THE INVENTION

The present invention provides an image forming apparatus capable of enhancing ease of operation for setting information on a print process.

An image forming apparatus of the present invention includes first storage means that stores first fiber information in one or more places on a first image recording medium; second storage means that stores second fiber information in one or more places on a second image recording medium; related information storage means that reads the first fiber information and stores related information in which image information and page order corresponding to the first fiber information are related to each other; comparing means that compares the first fiber information and the second fiber information with each other, by use of the related information stored in the related information storage means, and thereby determines whether or not the first fiber information and the second fiber information match with each other; and image forming means that determines, by using the related information, the image information to be performed print settings inputted to the image forming apparatus, performs the print settings on the determined image information, and performs image forming processing, when the comparing means determines that the first fiber information and the second fiber information match with each other.

An image forming method of the present invention with which an image forming apparatus forms an image includes the steps of storing first fiber information in one or more places on a first image recording medium in first storage means; reading the first fiber information and storing related information in related information storage means, the related information containing image information and page order corresponding to the first fiber information and being related to each other; storing second fiber information in one or more places on a second image recording medium in second storage means; determining whether or not first fiber information and the second fiber information match with each other, by comparing the first fiber information with the second fiber information, by using the related information stored in the related information storage means; and determining, by using the related information, the image information to be performed print setting inputted to the image forming apparatus, performing the print settings on the determined image information, and forming the image, when the comparing means determines that the first fiber information and the second fiber information match with each other.

A program of the present invention makes a computer to execute the above steps.

A computer-readable storage medium of the present invention stores the program.

An image processing apparatus of the present invention includes printing medium characteristic storage means that stores, as characteristic data, fiber information in one or more places on an image recording medium; means that stores image data to be printed on the image recording medium; and related information recording means that stores the characteristic data of the image recording medium and the image data to be printed on the image recording medium in association with each other. The image processing apparatus includes reading means that reads the image recording medium; means that reads the characteristic data of the fiber information on the image recording medium by the reading means, and determines the associated image data from the characteristic data by the related information recording means; and means that performs a set print process on the determined image data.

The present invention enables utilizing a paper fingerprint for print settings requiring page selection. This enables providing the image forming apparatus capable of facilitating print settings.

Further features of the present invention will become apparent from the following description of exemplary embodiments (with reference to the attached drawings).

### BRIEF DESCRIPTION OF THE DRAWINGS

FIG. 1 is a block diagram illustrating the configuration of an image forming system according to one embodiment of the present invention;

FIG. 2 is an external view of an input/output device of an image forming apparatus according to the embodiment of the present invention;

FIG. 3 is a block diagram illustrating in more detail the configuration of a controller unit of the image forming apparatus according to the embodiment of the present invention;

FIG. 4 shows a conceptual representation of tile image data according to the embodiment of the present invention;

FIG. 5 is a block diagram of a scanner image processing unit according to the embodiment of the present invention;

FIG. 6 is a block diagram of a printer image processing unit according to the embodiment of the present invention;

FIG. 7 illustrates a copy standard screen of an operation unit according to the embodiment of the present invention;

FIG. 8 is a flowchart of a paper fingerprint information acquisition process according to the embodiment of the present invention;

FIG. 9 is a flowchart of a paper fingerprint information collation process according to the embodiment of the present invention;

FIG. 10 illustrates an example of print settings on the operation unit according to the embodiment of the present invention;

FIG. 11 is a flowchart illustrating operation at the press of a paper fingerprint information reading key according to the embodiment of the present invention;

FIG. 12 is a flowchart of an entry process by a paper fingerprint information management unit according to the embodiment of the present invention;

FIG. 13 illustrates the contents of a related table conceptually according to the embodiment of the present invention;

FIG. 14 is a general view of the overall process under interleaving setting conditions according to the embodiment of the present invention;

FIG. 15 illustrates an example of print settings on the operation unit according to the embodiment of the present invention;

FIG. 16 is a flowchart illustrating operation for a paper fingerprint information entry process according to the embodiment of the present invention;

FIG. 17 illustrates an example of print settings on the operation unit according to the embodiment of the present invention;

FIG. 18 is a flowchart of paper fingerprint information acquisition on fed paper according to another embodiment of the present invention;

FIG. 19 illustrates the registered paper fingerprint information and the latest acquired paper fingerprint information according to the embodiment of the present invention;

FIGS. 20A to 20D illustrate a method of calculating E_{1×1}, E_{2×1}, E_{n×1}, and E_{2n-1×1}, respectively;

FIGS. 21A to 21B illustrate a method of calculating E_{2n-1×2} and E_{2n-1×2}, respectively; and

FIGS. 22A to 22B illustrate a method of calculating E_{n×m} and E_{2n-1×2m}, respectively.

### DESCRIPTION OF THE EMBODIMENTS

Description will be given below with reference to the accompanying drawings with regard to the embodiments of the present invention, which is capable of achieving the advantageous effects of the present invention.

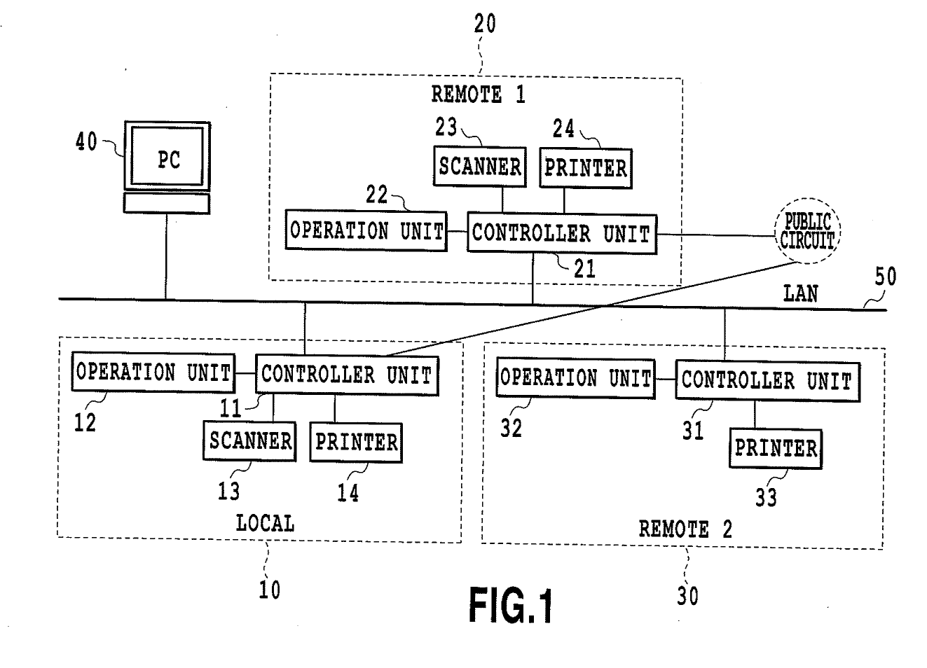

A “paper fingerprint” refers to fiber information of an image recording medium (e.g., paper), that is, a random pattern of paper fibers, such as roughness of the surface of the paper.

[Description of the Configuration of an Image Forming System (FIG. 1)]

FIG. 1 is a block diagram illustrating the configuration of the image forming system according to one embodiment of the present invention.

In the image forming system, a host computer 40 and three image forming apparatuses 10, 20 and 30 are connected to a LAN (local area network) 50. In the image forming system of the present invention, however, the numbers of computers and apparatuses connected are not limited to these. Although in the embodiment a LAN-based form is taken as a connection method for explanation, the connection method is not limited to this. For example, any given network such as a WAN (wide area network), a serial transmission system such as USB (Universal Serial Bus), a parallel transmission system such as centronics or SCSI (small computer system interface), and the like may be employed.

The host computer (hereinafter referred to as a “PC”) 40 has the function of a personal computer and includes a CPU (central processing unit) and memory such as ROM (read only memory) and RAM (random access memory) for program storage. Thus, the PC 40 can send and receive files or electronic mail via the LAN 50 (or the WAN, etc.), using an FTP (file transfer protocol) and an SMB (server message block) protocol. The PC 40 can also send print commands through a printer driver to the image forming apparatuses 10, 20 and 30, utilizing the functions of the CPU and programs mentioned above. The PC 40 can further make print settings such as interleaving paper (to be described later) on its screen and send the print settings to the image forming apparatuses 10, 20 and 30 via the network such as the LAN so that the image forming apparatuses perform image forming processing according to the print settings.

As shown in FIG. 1, the image forming apparatuses 10 and 20 have the same configuration. The image forming apparatus 30 has printing capability alone and does not have a scanner unit included in the image forming apparatuses 10 and 20.

For convenience of explanation, detailed description will hereinafter be given with regard to the configuration of the image forming apparatus 10.

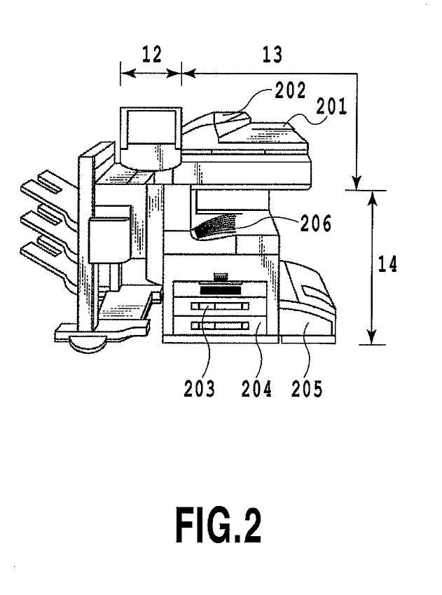

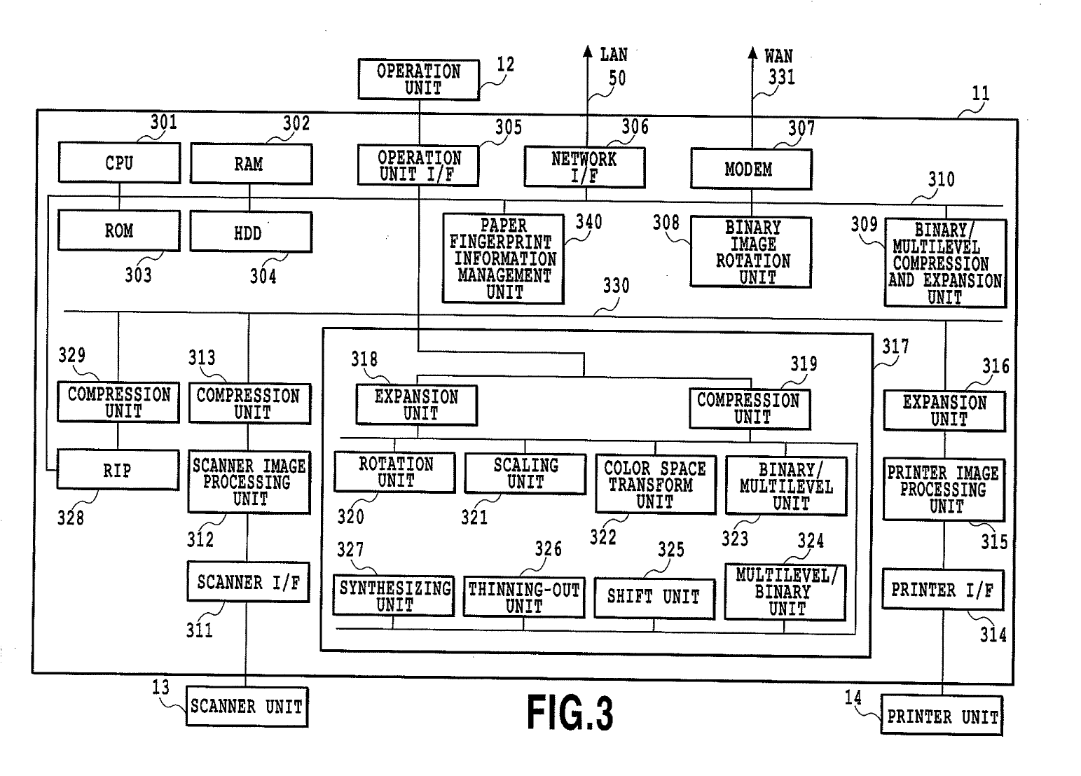

The image forming apparatus 10 includes a controller unit 11 that controls the apparatus as a whole, an operation unit 12 that serves as a user interface with print settings and the like, a scanner unit 13 that serves as an image input device, and a printer unit 14 that serves as an image output device. The operation unit 12, the scanner unit 13 and the printer unit 14 are controlled as a whole by the controller unit 11. Detailed description will be given with reference to FIG. 3 with regard to the detailed configuration of the controller unit 11.

[Description of the Outward Appearance of the Image Forming Apparatus 10 (FIG. 2)]

FIG. 2 shows the outward appearance of the image forming apparatus 10 according to the embodiment of the present invention shown in FIG. 1. The image forming apparatus 10 includes the controller unit 11 (not shown), the operation unit 12, the scanner unit 13, and the printer unit 14. The scanner unit 13 includes a document feeder 201 and a tray 202. The printer unit 14 includes plural paper cassettes 203, 204 and 205 that allow selection between different paper sizes or different paper orientations, and a copy receiving tray 206 that receives printed paper. The interleaving paper, as described as the embodiment of the present invention, is loaded in any one of the paper cassettes, and, if being interleaved, the paper is delivered from the paper cassette so that printed output is produced on the paper as will be described later.

The scanner unit 13 includes plural CCDs (charge coupled devices) that scan their respective assigned areas. When the CCDs are different in sensitivity, pixels, even if having the same gray level on an original, are recognized as being of different gray levels. To handle this problem, the scanner unit 13 first scans its own white plate (or uniformly white plate) by exposure, converts into an electric signal the amount of reflected light resulting from the scanning by exposure, and outputs the electric signal to the controller unit 11.

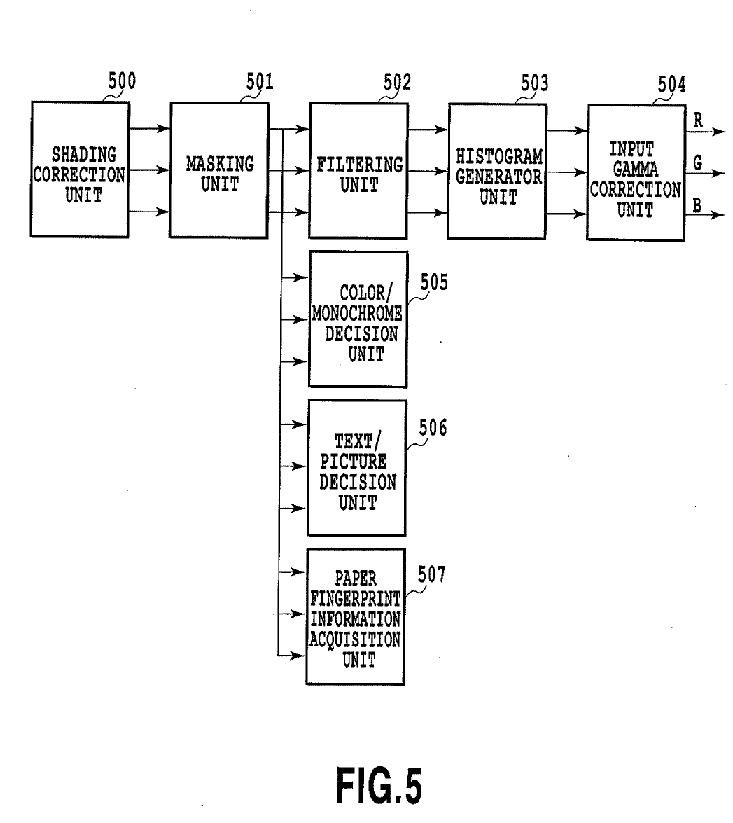

As will be described later, the controller unit 11 includes a scanner image processing unit 312 (see FIG. 3), and the scanner image processing unit 312 includes a shading correction unit 500 (see FIG. 5).

The shading correction unit 500 recognizes a difference in sensitivity between the CCDs, on the basis of the electric signals obtained from the CCDs, and corrects the value of the electric signal obtained through the scanning of an image on the original, utilizing the recognized difference in sensitivity.

Upon receipt of gain control information from a CPU 301 (see FIG. 3) in the controller unit 11, the shading correction unit 500 further performs gain control according to the information. The gain control is used to control the assignment of the value of the electric signal, obtained through the scanning of the original by exposure, to a brightness signal value being between 0 and 255. The gain control may be used to convert the above-mentioned value of the electric signal into a high or low brightness signal value.

Description will now be given with regard to a configuration for the scanning of the image on the original.

First, original documents are placed in the tray 202 of the document feeder 201. Upon receipt of an operator command to start reading via the operation unit 12, the controller unit 11 sends a command to read the original to the scanner unit 13.

Upon receipt of the command, the scanner unit 13 performs original reading operation on the original documents, one by one, fed from the tray 202 of the document feeder 201.

The scanner unit 13 converts image information into an electric signal by inputting, to the CCDs, reflected light resulting from the scanning of an image on the original by exposure.

The scanner unit 13 further converts the electric signal into RGB (red-green-blue) brightness signals and outputs the brightness signals as image data to the controller unit 11.

The above-mentioned method for reading the original is not limited to an automatic document feed using the document feeder 201. This method may be based on an approach that involves placing an original document on a glass plate (not shown) of the image forming apparatus 10 and scanning the original document, while moving the original document so that it travels through an exposure unit.

The printer unit 14 is an image forming device having the function of forming on paper the image data received from the controller unit 11.

An image forming method as employed in the embodiment is electrophotography using a photoconductive drum and a photoconductive belt, but the embodiment of the present invention is not limited to this. For example, ink jet printing that involves ejecting ink from an array of micro-nozzles to produce printed output on paper, or the like may be employed.

[Detailed Description of the Controller Unit 11 (FIG. 3)

FIG. 3 is a block diagram illustrating in more detail the configuration of the controller unit 11 of the image forming apparatus 10 according to the embodiment of the present invention. The controller unit 11 is electrically connected to the operation unit 12, the scanner unit 13 and the printer unit 14 and is also connected to an external device such as the PC 40 via the LAN 50 or a WAN 331. This configuration enables input and output of image data and device information. Description will be given below with regard to component parts of the controller unit 11.

The CPU 301 controls access to various devices (e.g., the scanner unit 13) under connection, based on a control program stored in ROM 303. The CPU 301 also controls various processes that take place within the controller unit 11.

RAM 302 serves as system work memory for the CPU 301 to operate and also serves as memory for temporarily storing image data. The RAM 302 includes SRAM (static RAM) that holds the stored contents after turn-off, and DRAM (dynamic RAM) that erases the stored contents after turn-off.

The ROM 303 stores a boot program for the apparatus, and so on, as mentioned above.

An HDD 304 is a hard disk drive and can store system software and image data.

An operation unit I/F (interface) 305 serves as an interface unit to provide a connection between a system bus 310 and the operation unit 12. The operation unit I/F 305 receives image data to be displayed on the operation unit 12 from the system bus 310 and transmits the image data to the operation unit 12, and also transmits information received from the operation unit 12 to the system bus 310.

A network I/F 306 has connections to the LAN 50 and the system bus 310 and transmits and receives information.

A modem 307 has connections to the WAN 331 and the system bus 310 and transmits and receives information.

The network I/F 306 and the modem 307 may be connected to an external computer such as the PC 40 via the LAN 50 and the WAN 331, respectively, to receive print settings from the PC 40 or the like.

A binary image rotation unit 308 transforms the orientation of image data yet to be transmitted.

A binary/multilevel image compression and expansion unit 309 transforms the resolution of image data yet to be transmitted into a predetermined resolution or a resolution according to the resolving power of the destination of the image data. The JBIG (joint bi-level image experts group), MMR (modified modified READ (relative element address designate)) coding, MR (modified READ) coding, MH (modified Huffman) coding, or the like is used for compression and expansion.

An image bus 330 serves as a transmission line for image data communications and is configured of a PCI (peripheral component interconnect) bus or IEEE 1394.

The scanner image processing unit 312 performs correction, processing and editing on image data received from the scanner unit 13 via a scanner I/F 311. The scanner image processing unit 312 can also determine whether the received image data is a color document or a monochrome document, determine whether the received image data is a text document or a photo document, and do the like. The scanner image processing unit 312 further performs a process for associating the result of determination with the image data. Such associated information is herein called “attribute data”. A detailed description will be given with reference to FIG. 5 with regard to the details of processing that takes place in the scanner image processing unit 312.

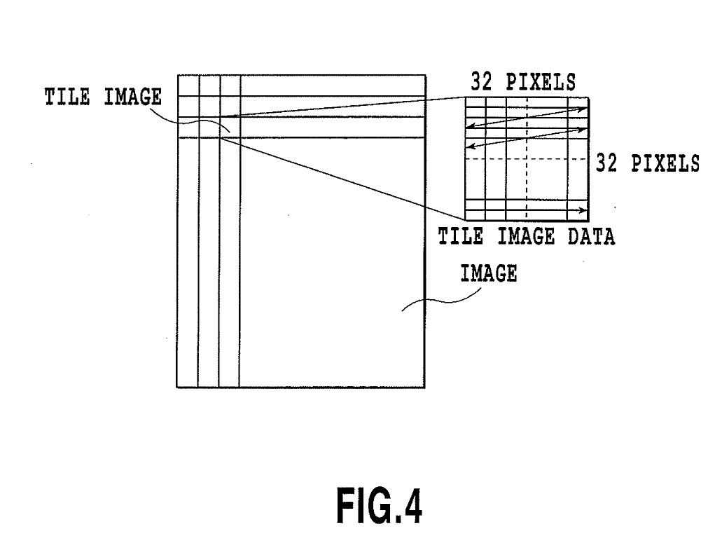

A compression unit 313 receives image data from the scanner image processing unit 312 and divides the image data into block units each composed of 32×32 pixels. The image data of 32×32 pixels is called “tile image data”. FIG. 4 shows a conceptual representation of the tile image data. A region, corresponding to the tile image data, of an original document (or a paper medium yet to be read by the scanner unit 13) is called a “tile image”.

The tile image data has header information, containing average brightness information of the block of 32×32 pixels and the coordinates of the tile image on the original document. The compression unit 313 further compresses the image data composed of plural tile image data.

An expansion unit 316 expands the image data composed of the plural tile image data and rasterizes the image data, which in turn is transmitted to a printer image processing unit 315.

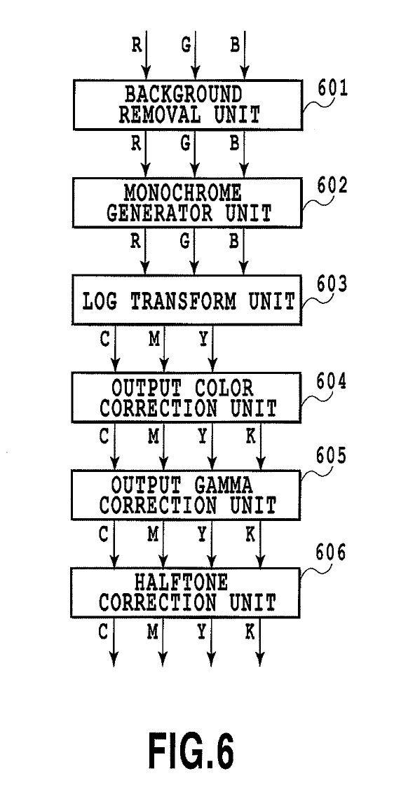

The printer image processing unit 315 receives the image data from the expansion unit 316, refers to the attribute data associated with the image data, and performs image processing on the image data. After having undergone the image processing, the image data is outputted to the printer unit 14 via a printer I/F 314. Detailed description will be given with reference to FIG. 6 with regard to the details of processing that takes place in the printer image processing unit 315.

An image transform unit 317 performs a predetermined transform process to image data. The image transform unit 317 includes processing units as given below.

An expansion unit 318 expands received image data. A compression unit 319 compresses received image data. A rotation unit 320 rotates received image data.

A scaling unit 321 performs a resolution transform process to received image data. For example, a scaling unit 321 performs a resolution transform process from 600 to 200 dpi (dots per inch).

A color space transform unit 322 transforms the color space of received image data. Using a matrix or a table, the color space transform unit 322 can also implement known techniques, namely, a background removal process, a log transform process (that is, transformation from RGB to CMY (cyan-magenta-yellow)), and an output color correction process (that is, transformation from CMY to CMYK (cyan-magenta-yellow-black)).

A binary/multilevel transform unit 323 transforms received image data having 2-level gray scale into image data having 256-level gray scale.

A multilevel/binary transform unit 324 transforms received image data having 256-level gray scale into image data having 2-level gray scale through an approach such as an error diffusion process.

A shift unit 325 performs a process for adding or deleting a margin to or from received image data.

A thinning-out unit 326 thins out pixels of received image data to perform a resolution transform and produce, for example, image data whose resolution is ½, ¼ or ⅛ of that of original image data.

A synthesizing unit 327 synthesizes two received image data to form one image data. The well-known methods can be utilized to synthesize two image data. Specifically, the approach of using as a resultant brightness value an average value of the brightness values of pixels to be synthesized, the approach of using as a resultant pixel brightness value the brightness value of a bright pixel as viewed at brightness level, or the approach of using a dark pixel as a resultant pixel can be employed. Furthermore, an approach in which pixels to be synthesized are operated using an operation such as OR, AND, or EXCLUSIVE-OR operation to determine a resultant brightness value may be utilized.

ARIP (raster image processor) 328 receives intermediate data generated on the basis of PDL (page description language) code data transmitted from the PC 40 and generates bitmap data (multilevel).

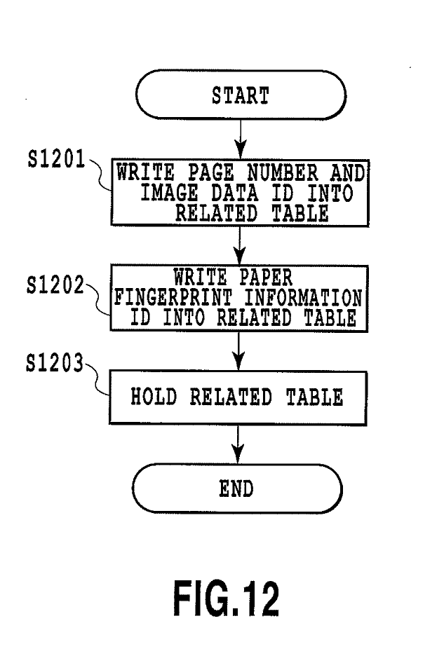

A paper fingerprint information management unit 340 manages paper fingerprint information obtained through the processing by the scanner image processing unit 312, in correlation with image data. Description will be given with reference to FIG. 12 with regard to the details of processing that takes place in the paper fingerprint information management unit 340.

[Detailed Description of the Scanner Image Processing Unit 312 (FIG. 5)

FIG. 5 shows the details of the internal configuration of the scanner image processing unit 312 shown in FIG. 3.

The scanner image processing unit 312 has the function of receiving image data composed of RGB brightness signals, each of which is 8 bits of data.

The shading correction unit 500 performs shading correction on the brightness signals. The shading correction refers to a process for preventing the erroneous recognition of the brightness of the original due to variations in sensitivity between the CCDs, as mentioned above. The shading correction unit 500 can further perform gain control under a command from the CPU 301.

A masking unit 501 converts the shading-corrected brightness signals received from the shading correction unit 500 into standard brightness signals which do not depend on filter colors of the CCDs.

A filtering unit 502 arbitrarily corrects the spatial frequency of image data received from the masking unit 501. The filtering unit 502 performs arithmetic processing for the image data using a 7 by 7 matrix, for example.

A copying machine and a combined machine can select text mode, picture mode, or text/picture mode, as copy mode. When the text mode is selected from these modes, the filtering unit 502 filters an entire area of the image data using a filter for text. When the picture mode is selected, the filtering unit 502 filters an entire area of the image data using a filter for picture. When the text/picture mode is selected, the filtering unit 502 performs switching to select an adaptable filter for each pixel in accordance with a text/picture decision signal which is a portion of the attribute data. In other words, the filtering unit 502 determines whether the filtering for picture or the filtering for text should be made for each pixel.

A filter for picture is set to have such a factor as permits smoothing of high frequency components alone, so that jaggies on an image can become unnoticeable. Meanwhile, a filter for text is set to have such a factor as permits somewhat intense edge enhancement, so that characters can become sharp.

A histogram generator unit 503 samples brightness data of the pixels that constitute the image data received from the filtering unit 502. More specifically, the histogram generator unit 503 samples the brightness data in a rectangular region defined by starting points and endpoints specified in main scan direction and sub-scan direction, respectively, in given pitches in the main scan direction and sub-scan direction. Then, the histogram generator unit 503 generates histogram data using the sampled data. The generated histogram data is used to estimate background level for the background removal process.

An input gamma correction unit 504 performs conversion into brightness data having nonlinearity by utilizing a table or the like.

A color/monochrome decision unit 505 determines whether each of the pixels that constitute the image data received from the masking unit 501 has a chromatic color or an achromatic color, and associates the result of determination as a color/monochrome decision signal (which is a portion of the attribute data) with the image data.

A text/picture decision unit 506 determines whether each of the pixels that constitute the image data received from the masking unit 501 is a pixel that constitutes text, a pixel that constitutes a dot, a pixel that constitutes text in a dot, or a pixel that constitutes a solid image. In this case, the text/picture decision unit 506 makes a determination based on the pixel value of each pixel and the pixel values of peripheral pixels around each pixel. A pixel that does not apply to any of the above pixels is judged as a pixel that constitutes a white region. After this decision making process, the text/picture decision unit 506 associates the result of determination as a text/picture decision signal which is a portion of the attribute data with the image data.

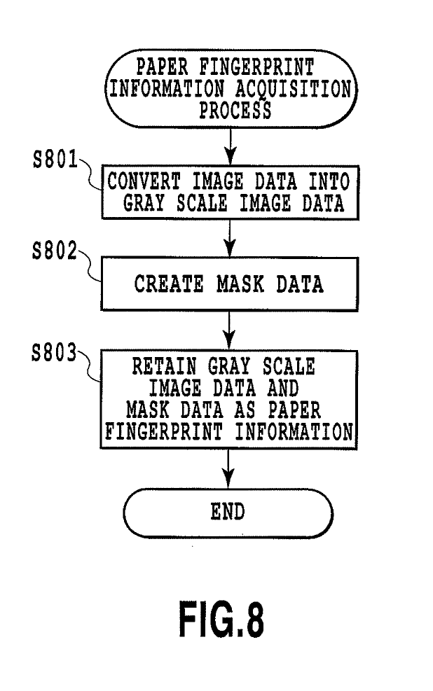

A paper fingerprint information acquisition unit 507 acquires image data in a predetermined region (i.e. at least one or more regions), of RGB image data inputted to the masking unit 501 by the shading correction unit 500, from the masking unit 501. Detailed description will be given below with reference to FIG. 8 with regard to the details of a paper fingerprint information acquisition process that is made by the paper fingerprint information acquisition unit 507.

[Detailed Description of the Paper Fingerprint Information Acquisition Unit 507 (FIG. 8)]

FIG. 8 is a flowchart illustrating the paper fingerprint information acquisition process that is made by the paper fingerprint information acquisition unit 507 shown in FIG. 5. The paper fingerprint information acquisition unit 507 is controlled by the CPU 301 of the controller unit 11.

At step S801, the paper fingerprint information acquisition unit 507 converts the acquired image data into gray scale image data.

At step S802, the paper fingerprint information acquisition unit 507 creates mask data for collation by eliminating the possible causes of misjudgment, including printed and handwritten text, based on the gray scale image data. The mask data refers to binary data, namely, “0” or “1”.

When a pixel of the gray scale image data has a brightness signal value equal to or more than a first threshold value (which means to be bright), the paper fingerprint information acquisition unit 507 sets the value of the mask data to “1”. When a pixel of the gray scale image data has a brightness signal value less than the first threshold value (which means to be dark), the paper fingerprint information acquisition unit 507 sets the value of the mask data to “0”.

The paper fingerprint information acquisition unit 507 performs the above processing on each of pixels contained in the gray scale image data.

At step S803, the paper fingerprint information acquisition unit 507 acquires two data, namely, the gray scale image data and the mask data, as paper fingerprint information, and transmits the paper fingerprint information in the predetermined region via a data bus (not shown) to the RAM 302, which in turn retains the paper fingerprint information.

[Detailed Description of the Printer Image Processing unit 315 (FIG. 6)]

Description will now be given with reference to FIG. 6 with regard to the flow of processing by the printer image processing unit 315 shown in FIG. 3.

A background removal unit 601 performs a process for blanking (or removing) a background color of image data, using a histogram generated by the scanner image processing unit 312.

A monochrome generator unit 602 converts color data into monochrome data.

A log transform unit 603 performs a brightness transform and a gray level transform. For example, the log transform unit 603 converts input RGB image data into CMY image data.

An output color correction unit 604 performs output color correction. For example, the output color correction unit 604 converts input CMY image data into CMYK image data, using a table or a matrix.

An output gamma correction unit 605 performs correction so that an input signal value to the output gamma correction unit 605 is proportional to a reflection density value after the production of copied output.

A halftone correction unit 606 performs a halftone process in accordance with the number of gray level of the printer unit 14. For example, the halftone correction unit 606 performs a binarization or 32-level process on received image data having a high gray level.

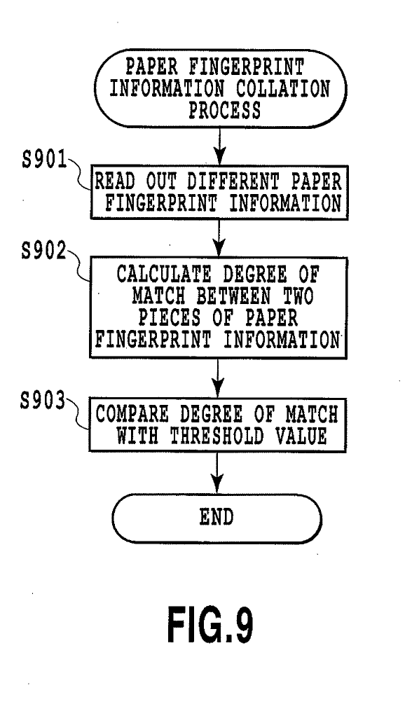

The scanner image processing unit 312 and the printer image processing unit 315 may be configured so that received image data is output without being processed. The passage of data through a given processing unit without the data being processed, as mentioned above, is expressed as “to let the data through the processing unit”.

[A Paper Fingerprint Information Collation Process (FIG. 9)]

Description will now be given with reference to FIG. 9 with regard to the paper fingerprint information collation process. FIG. 9 is a flowchart illustrating the paper fingerprint information collation process. The CPU 301 controls each step in the flowchart.

The CPU 301 can read out paper fingerprint information transmitted from the paper fingerprint information acquisition unit 507 to the RAM 302 and collate the read-out paper fingerprint information with different paper fingerprint information. The different paper fingerprint information refers to paper fingerprint information managed by the paper fingerprint information management unit 340 or paper fingerprint information stored in other storage media such as a server and refers to paper fingerprint information to be collated.

At step S901, the CPU 301 reads out from the RAM 302 the paper fingerprint information managed by the paper fingerprint information management unit 340 or the paper fingerprint information stored in the server (that is, the paper fingerprint information to be collated).

At step S902, the CPU 301 calculates the degree of match between two pieces of paper fingerprint information, using Equation (1), in order to collate the paper fingerprint information transmitted from the paper fingerprint information acquisition unit 507 (that is, paper fingerprint information for collation) with the paper fingerprint information read out at step S901.

It is assumed that one paper fingerprint information is shifted from the other paper fingerprint information. Calculations are performed using a function expressed by Equation (1) while shifting the one paper fingerprint information pixel by pixel. When the function of Equation (1) has a minimum value, that is, when the smallest difference arises between the two pieces of paper fingerprint information, an error image (E) between the two pieces of paper fingerprint information is obtained.

E=(α₁ᵢf₁ᵢ² [symbol] α₂ᵢ)−2(α₁ᵢf₁ᵢ [symbol] α₂ᵢf₂ᵢ)+(α₁ᵢ [symbol] α₂ᵢf₂ᵢ²) (1)

In Equation (1), α₁ represents mask data in the paper fingerprint information retrieved at step S901, and f₁ represents gray scale image data in the paper fingerprint information retrieved at step S901. Further, α₂ represents mask data in the paper fingerprint information transmitted from the paper fingerprint information acquisition unit 507 at step S902, and f₂ represents gray scale image data in the paper fingerprint information transmitted from the paper fingerprint information acquisition unit 507 at step S902.

To numerically express the result of paper fingerprint information collation based on the error image, the following process is performed. The brightness signal values of pixels of the error image obtained by the function of Equation (1) are reversed to change into negative values. Further, the average of the negative values is calculated, and difference values between the average value and the negative values are calculated. Then, a standard deviation is calculated from the calculated difference values, and quotients are obtained by dividing the negative values by the standard deviation. Finally, the maximum value of the obtained quotients is taken as the degree of match between the two pieces of paper fingerprint information. As a result, the degree of match between these pieces of paper fingerprint information is expressed as a value not less than zero. The larger the value of the degree of match, the higher the degree of match between the two pieces of paper fingerprint information.

At step S903, a comparison is performed between the degree of match between the two pieces of paper fingerprint information calculated at step S902 and a predetermined threshold value to determine whether the degree of match is “valid” or “invalid”.

FIG. 9 is a flowchart showing the paper fingerprint information collation process for paper fingerprint information having image data added. Steps S901 to S903 are as mentioned above. Step S902 calculates the degree of match between image data in the paper fingerprint information transmitted from the paper fingerprint information acquisition unit 507 and image data in the paper fingerprint information retrieved at step S901. The calculation of the degree of match between the image data can be accomplished by doing collation to determine a “match” or “mismatch” bit by bit. If a mismatch does not occur throughout the entire image data, the degree of match is judged as an “exact match”. The calculation of the degree of match between the image data may be performed allowing for a somewhat inexact match. In this case, a threshold value is predefined as a tolerance. At step S903, a comparison is performed between the degree of match between the image data and the threshold value to determine whether the degree of match is “valid” or “invalid”. The description of the controller 11 is as given above.

$$E ( i , j ) = \frac{{\sum }_{x , y} {α}_{1} ( x , y ) {α}_{2} ( x - i , y - j ) {\{ {f}_{1} ( x , y ) - {f}_{2} ( x - i , y - j ) \}}^{2}}{{\sum }_{x , y} {α}_{1} ( x , y ) {α}_{2} ( x - i , y - j )} \qquad ( 2 )$$

In Equation (2), ay represents mask data in the paper fingerprint information (or the previously registered paper fingerprint information) retrieved at step S901. In Equation (2), f₁ represents gray scale image data in the paper fingerprint information (or the previously registered paper fingerprint information) retrieved at step S901. Further, α₂ represents mask data in the paper fingerprint information (or the just-retrieved paper fingerprint information) transmitted from the paper fingerprint information acquisition unit 507 at step S902 and f₂ represents gray scale image data in the paper fingerprint information (or the just-retrieved paper fingerprint information) transmitted from the paper fingerprint information acquisition unit 507 at step S902.

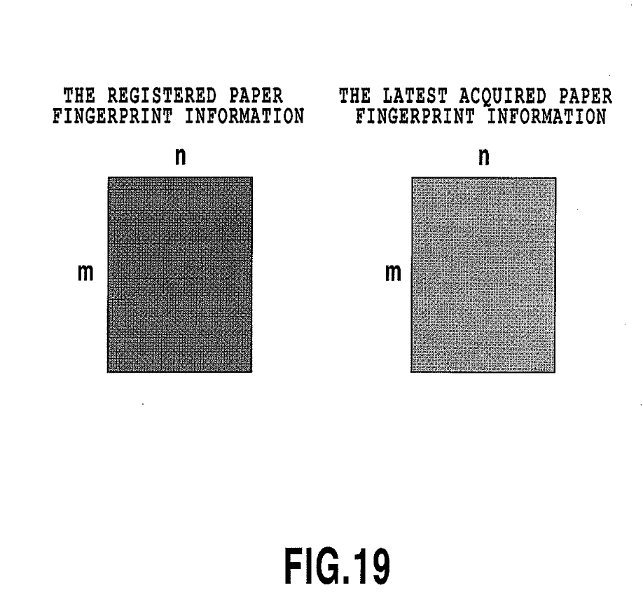

A specific method will be described with reference to FIGS. 19, 20A to 20D, 21A and 21B, and 22A and 22B. FIG. 19 illustrates the registered paper fingerprint information and the latest acquired paper fingerprint information. It is assumed that these pieces of information are each composed of n pixels wide by m pixels high.

A set of (2n−1)×(2m−1) error values E(i, j) between the registered paper fingerprint information and the latest acquired paper fingerprint information are calculated by using the function expressed by Equation (2) while shifting i and j within a range of −n+1 to n−1 and within a range of −m+1 to m−1, respectively, pixel by pixel. In other words, the error values E(−n+1, −m+1) to E(n−1, m−1) are calculated.

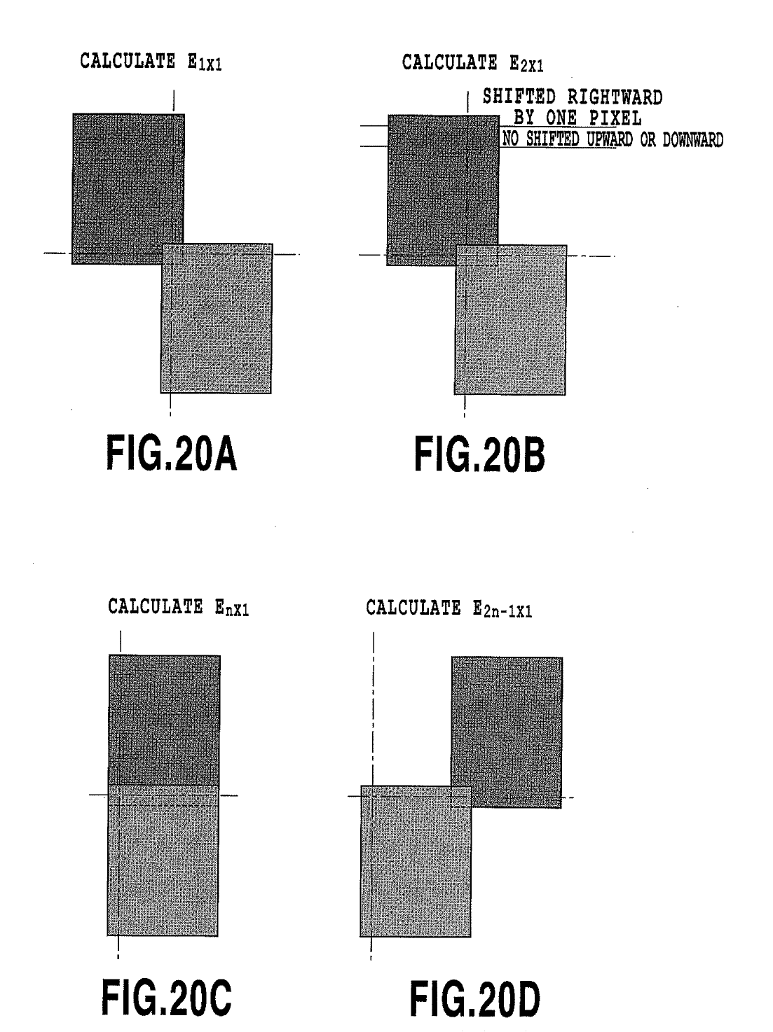

FIG. 20A illustrates a superposition of the lowermost and rightmost pixel of the latest acquired paper fingerprint information on the uppermost and leftmost pixel of the registered paper fingerprint information. Under this condition, the value obtained by the function of Equation (2) is taken as E (−n+1, −m+1). FIG. 20B illustrates the latest acquired paper fingerprint information as shifted rightward by one pixel relative to the position shown in FIG. 20A. Under this condition, the value obtained by the function of Equation (1) is taken as E(−n+2, −m+1). As mentioned above, calculations are performed while shifting the latest acquired paper fingerprint information. FIG. 20C shows the latest acquired paper fingerprint information as shifted to be superposed on the registered paper fingerprint information, and the value E (0, −(m−1))) is obtained. FIG. 20D shows the latest acquired paper fingerprint information as further shifted to the right end, and the value E(n−1, −m+1) is obtained. As mentioned above, when the paper fingerprint information is shifted horizontally, the i value of E(i, j) is incremented by 1.

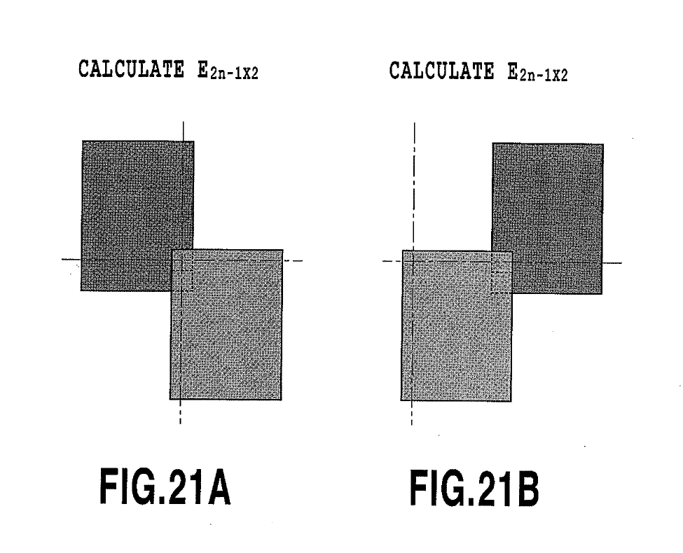

Likewise, FIG. 21A shows the latest acquired paper fingerprint information as shifted downward by one pixel relative to the position shown in FIGS. 20A to 20D, and the value E(−n+1, −m+2) is obtained.

FIG. 21B shows the latest acquired paper fingerprint information as further shifted to the right end relative to the position shown in FIG. 21A, and the value E (n−1, −m+2) is obtained.

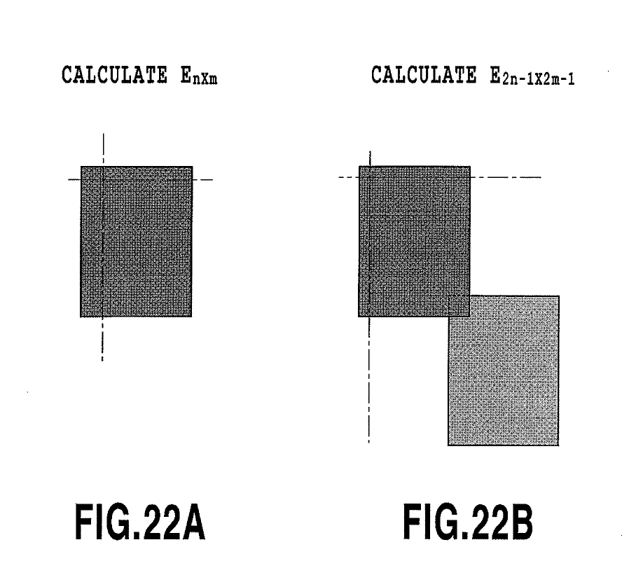

FIG. 22A shows an instance where the registered paper fingerprint information and the latest acquired paper fingerprint information are located at the same position. The value E(i, j) of this instance is taken as E(0, 0).

As mentioned above, calculations are performed while shifting the image in such a manner that at least one or more pixels of the latest acquired paper fingerprint information are superposed on those of the registered paper fingerprint information. Finally, as shown in FIG. 22B, the value E(n−1, m−1) is calculated.

A set of (2n−1)×(2m−1) error values E (i, j) is obtained in this manner.

In order to discuss the meaning of Equation (2), consider an instance where i=0 and j=0, α₁(x, y)=1 (x=0 to n, y=0 to m), and α₂ (x-i, y-j)=1 (x=0 to n, y=0 to m). In other words, the value E(0, 0) is obtained under a condition where α₁(x, y)=1 (x=0 to n, y=0 to m) and α₂ (x-i, y-j)=1 (x=0 to n, y=0 to m).

Incidentally, i=0 and j=0 indicate that the registered paper fingerprint information and the latest acquired paper fingerprint information are located at the same position as shown in FIG. 22A.

As employed herein, α₁(x, y)=1 (x=0 to n, y=0 to m) indicates that all pixels of the registered paper fingerprint information are bright. In other words, this indicates that there has been no coloring material such as toner or ink, and no dust, on a paper fingerprint acquisition region at the time of acquisition of the registered paper fingerprint information.

Moreover, α₂(x-i, y-j)=1 (x=0 to n, y=0 to m) indicates that all pixels of the latest acquired paper fingerprint information are bright. In other words, this indicates that there has been no coloring material such as toner or ink, and no dust, on a paper fingerprint acquisition region at the time of acquisition of the just-acquired paper fingerprint information.

When α₁(x, y)=1 and α₂(x-i, y-j)=1 hold for all pixels as mentioned above, Equation (2) is expressed as Equation (3):

$$E ( 0 , 0 ) = {\sum }_{x = 0 , y = 0}^{n , m} {\{ {f}_{1} ( x , y ) - {f}_{2} ( x , y ) \}}^{2} \qquad ( 3 )$$

where {f₁(x,y)−f₂(x,y)}² represents the squared value of a difference between the gray scale image data in the registered paper fingerprint information and the gray scale image data in the just-retrieved paper fingerprint information. Accordingly, Equation (3) leads to the sum of the squared values of differences between pixels of two pieces of paper fingerprint information. In other words, the larger the number of pixels having similarity between f₁(x, y) and f₂(x, y) becomes, the smaller the value E(0, 0) becomes.

The above description is given for the way to calculate the value E(0, 0), and other values E(i, j) are calculated in the same manner. It can be seen that, if E(k,l)=min{E(i,j)}, the position where the registered paper fingerprint information is acquired is shifted by k and l from the position where the just-acquired paper fingerprint information is acquired, based on the fact that the larger number of pixels having similarity between f₁ (x, y) and f₂ (x, y) leads to the smaller value E(i, j).

(The Significance of α)

The numerator of Equation (2) indicates {f₁(x,y)−f₂(x-i, y-j)}² multiplied by α₁ and α₂ (to be precise, a sum is further calculated by using the sigma (Σ) sign). As employed herein, α₁ and α₂ take “0” for a pixel of a dark color and “1” for a pixel of a light color.

Therefore, α₁α₂{f₁(x,y)−2(x-i,y-j)}² is equal to zero if either one (or both) of α₁ and α₂ is equal to zero.

In other words, this indicates that, if a target pixel of either one (or both) of two pieces of paper fingerprint information has a dark color, allowance is not made for a gray level difference of the pixel. This is performed for the purpose of neglecting a pixel having dust or an unnecessary coloring material.

Since this process causes variations in the number of values summed by the sigma (Σ) sign, normalization is performed by division by the total number, Σα₁(x,y)α₂(x-i,y-j). It is assumed that the error value E(i, j) at which Σα₁(x,y)α₂(x-i,y-j) in the denominator of Equation (2) becomes equal to zero is not contained in a set of error values to be described later (E(−(n−1), −(m−1)) to E(n−1, m−1)).

(A Method of Determining the Degree of Match)

As mentioned above, it can be seen that, if E(k,l)=min{E(i,j)}, the position where the registered paper fingerprint information is acquired is shifted by k and l from the position where the just-acquired paper fingerprint information is acquired.

Then, a value indicative of the degree of similarity between two pieces of paper fingerprint information (this value is herein called the “degree of match”) is calculated by using the value E(k, l) and other values E(i, j).

First, the average value (40) is calculated from the set of the error values (for example, E(0, 0)=10*, E(0, 1)=50, E(1, 0)=50, E(1, 1)=50) obtained by using the function of Equation (2). ( . . . (A))

The mark * has nothing to do with a value and is merely for the purpose of notice. The reason why notice should be taken of it will be described later.

Then, a new set (30*, −10, −10, −10) is obtained by subtracting the error values (10*, 50, 50, 50) from the average value (40). . . . (B)

Then, a standard deviation (30×30+10×10+10×10+10×10=1200, 1200/4=300, \sqrt{300}=10\sqrt{3}=approximately 17) is calculated from the new set. Then, quotients (1*, −1, −1, −1) are obtained by dividing the new set by 17. . . . (C)

Then, the maximum value of the resultant values is taken as the degree of match (1*). The value, 1*, is the value corresponding to the value, E(0, 0)=10*. In this case, E(0, 0) is the value that satisfies E(0,0)=min{E(i,j)}.

(Conceptual Description of the Method of Determining the Degree of Match)

The above process for the method of determining the degree of match eventually calculates the degree of a difference between the smallest error value in the set of plural error values and the average error value (the above (A) and (B)).

Then, the degree of match is calculated by dividing the degree of the difference by the standard deviation (the above (C)).

Finally, the result of collation is obtained by comparing the degree of match with the threshold value (the above (D)).

The standard deviation refers to the average value of “the differences between the error values and the average value”. In other words, the standard deviation is the value indicative of the degree of variance that occurs throughout the set.

The degree of the difference can be divided by the variance value throughout the set to see to what extent the value min{E(i, j)} is small in the set E(i, j) (or whether the value is outstandingly small or a little small).

If the value min{E(i, j)} is very outstandingly small in the set E (i, j), the value is judged as being valid, or otherwise the value is judged as being invalid (the above (D)).

(The reason why the value min{E(i, j)} is judged as being valid only when the value is very outstandingly small in the set E(i, j))

It is assumed that the registered paper fingerprint information and the just-acquired paper fingerprint information are acquired from the same paper.

Thus, there must be a place (that is, a slightly slided position) where the registered paper fingerprint information extremely closely matches the just-acquired paper fingerprint information. At this point, E(i, j) must become very small because the registered paper fingerprint information extremely closely matches the just-acquired paper fingerprint information at the slightly slided position.

If the image is further slided by any amount from the slightly slided position, there is no correlation between the registered paper fingerprint information and the just-acquired paper fingerprint information. Therefore, E(i, j) must become a typical large value.

Thus, the condition that “two pieces of paper fingerprint information are acquired from the same paper” coincides with the condition that “the smallest E(i, j) value is outstandingly small in the set E(i, j)”.

Description will be given again with regard to the [A paper fingerprint information collation process].

At step S903, a comparison is performed between the degree of match between the two pieces of paper fingerprint information calculated at step S902 and the predetermined threshold value to determine whether the degree of match is “valid” or “invalid”. The degree of match is also called the “degree of similarity”. Moreover, the result of comparison between the degree of match and the predetermined threshold value is also called the “result of collation”.

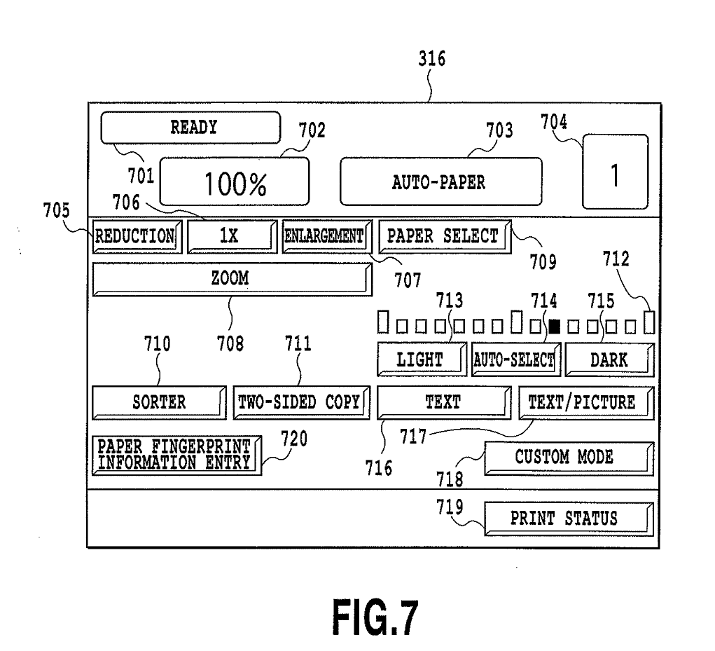

The description of the controller 11 is as given above.

[Description of an Operating Screen (FIG. 7)]

Description will now be given with reference to FIG. 7 with regard to a copy standard screen on an operation panel according to the embodiment of the present invention. The image forming apparatus 10 is configured to display the copy standard screen as a default display at turn-on.

Reference numeral 701 denotes a message line, on which a message is displayed to indicate the status of copy jobs.

Reference numeral 702 denotes a magnification indicator, which indicates, on a percentage basis, a specified magnification or a magnification automatically selected according to the copy mode.

Reference numeral 703 denotes a paper size indicator, which indicates selected copying paper or displays the message “auto-paper” if automatic paper select mode is selected.

Reference numeral 704 denotes a numeric indicator, which indicates the number of copies to be made.

Reference numeral 705 denotes a reduction key, which is used to make a reduced copy.

Reference numeral 706 denotes a 1× key, which is used to reset the magnification in order to restore it from reduction or enlargement mode to 1× mode.

Reference numeral 707 denotes an enlargement key, which is used to make an enlarged copy.

Reference numeral 708 denotes a zoom key, which is used to set the magnification in small units for a reduced or enlarged copy.

Reference numeral 709 denotes a paper select key, which is used to select copying paper.

Reference numeral 710 denotes a sorter key, which is used to select sort or staple mode.

Reference numeral 711 denotes a two-sided copy key, which is used to select two-sided copy mode.

Reference numeral 712 denotes an image density indicator, which is configured so that the current image density can be seen therefrom. The image density indicator 712 indicates low image densities in the left-hand part of the indicator and indicates high image densities in the right-hand part of the indicator. The image density indicator 712 also provides varying indications in connection with a light key 713 and a dark key 715.

Reference numeral 713 denotes the light key, which is used to decrease the image density.

Reference numeral 714 denotes an auto-select key, which is used to select automatic density select mode.

Reference numeral 715 denotes the dark key, which is used to increase the image density.

Reference numeral 716 denotes a text key, which is used to select the “text mode” in which the image density suitable for copying of text documents is automatically selected.

Reference numeral 717 denotes a text/picture key, which is used to select the “text/picture mode” in which the image density suitable for copying of mixed text-and-photo documents is automatically selected.

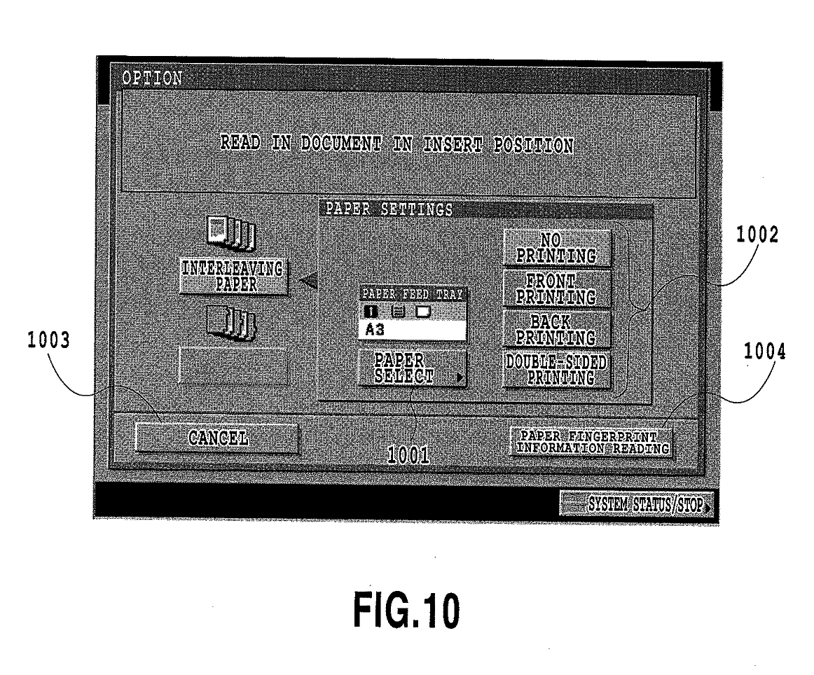

Reference numeral 718 denotes a custom mode key, which is used to select various copy modes that cannot be selected on the copy standard screen. Description will be given with reference to FIGS. 10, 15 and 17 with regard to instances where the custom mode key 718 is pressed down for selection.

Reference numeral 719 denotes a print status key, which is used for a user to check the present status of print. The print status key 719 is not limited to appearing on the copy standard screen but appears at the illustrated position at all times, and thus the key 719 can be pressed at any time for the user to check the print status.

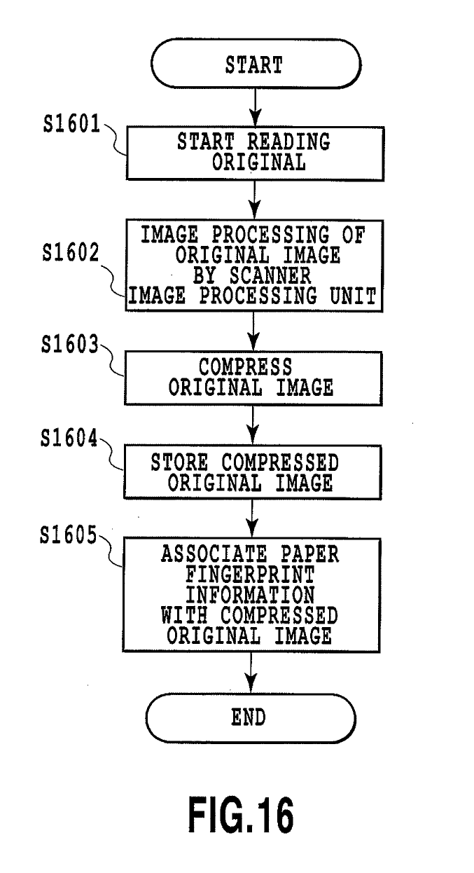

A paper fingerprint information entry tab 720 serves to select an entry process for paper fingerprint information to be collated. Description will be given with reference to FIG. 16 with regard to the paper fingerprint information entry process.

When a start key (not shown) is pressed down, the image forming apparatus 10 executes a print process according to print settings made with the press of various keys shown in FIG. 7.

[Operation at the Press of the Paper Fingerprint Information Entry Tab 720 (FIG. 16)]

Description will now be given with reference to FIG. 16 with regard to the paper fingerprint information entry process that is executed when the paper fingerprint information entry tab 720 shown in FIG. 7 is pressed down.

At step S1601, the CPU 301 performs control so that image data on an original read by the scanner unit 13 is transmitted to the scanner image processing unit 312 via the scanner I/F 311.

At step S1602, the scanner image processing unit 312 performs the processing described above with reference to FIG. 5 to the image data and produces attribute data in conjunction with new image data, after the shading correction unit 500 has set a general gain control value. The scanner image processing unit 312 also performs a process for associating the attribute data with the image data. In the scanner image processing unit 312, further, the shading correction unit 500 sets a smaller gain control value than the general gain control value. Then, the scanner image processing unit 312 outputs to the paper fingerprint information acquisition unit 507 brightness signal values obtained through the application of the smaller gain control value to the image data. The paper fingerprint information acquisition unit 507 performs the process described with reference to FIG. 8, according to the output data, to acquire paper fingerprint information. The scanner image processing unit 312 transmits the acquired paper fingerprint information to the RAM 302 via the data bus (not shown).

At step S1603, the compression unit 313 divides the new image data produced by the scanner image processing unit 312 into block units each composed of 32×32 pixels to form plural tile image data. The compression unit 313 further compresses the image data including the plural tile image data.

At step S1604, the CPU 301 performs control so that the image data compressed by the compression unit 313 is transmitted to and stored in the RAM 302. The image data is transmitted to the image transform unit 317 to undergo image processing as needed, and thereafter the image data is again transmitted to and stored in the RAM 302.

At step S1605, the paper fingerprint information management unit 340 manages the paper fingerprint information acquired at step S1602, in association with the image data, corresponding to the paper fingerprint information, formed at step S1603, and the related information is stored as paper fingerprint management information in the RAM 302.

[Description of the Paper Fingerprint Information Management Unit 340 (FIG. 12)]

Description will now be given with reference to a flowchart of FIG. 12 with regard to an entry process for paper fingerprint information management that is made by the paper fingerprint information management unit 340.

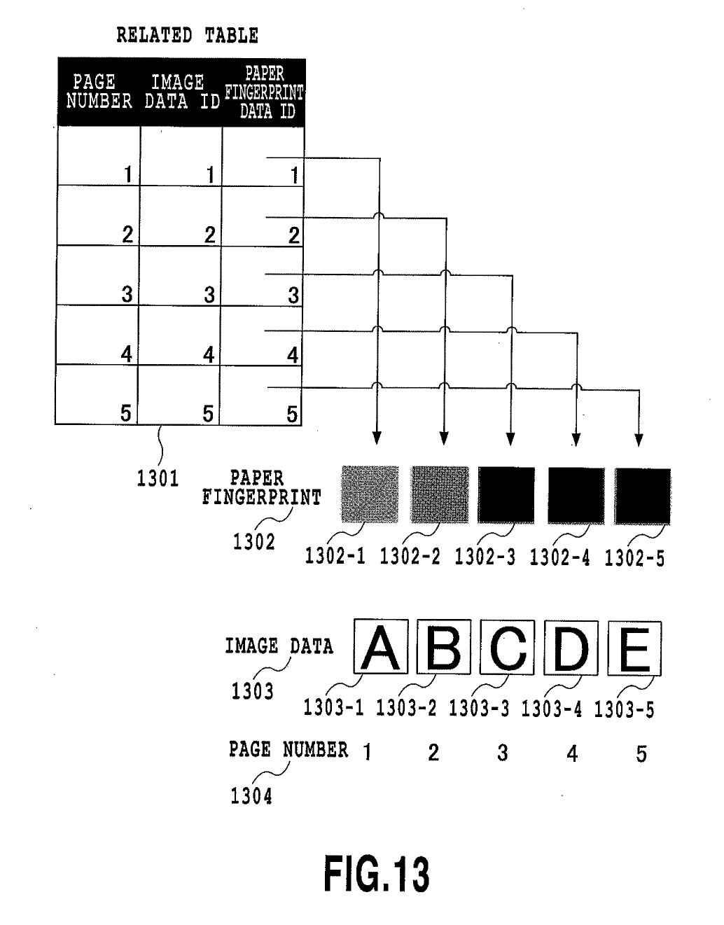

At step S1201, the paper fingerprint information management unit 340 writes the image data stored in the RAM 302 at step S1604 of FIG. 16, in conjunction with page number information assigned in the order of storage, into a related table managed in the RAM 302. The related table is formed of related information “page number—image information (or image data)—paper fingerprint information”. Detailed description will be given with reference to FIG. 13 with regard to the details of the related table.

The paper fingerprint information management unit 340 assigns an ID that is uniquely manageable in the apparatus to the image data in order to form information to be written into the related table, and writes the ID as an image data ID into the related table.

At step S1202, the paper fingerprint information management unit 340 reads out paper fingerprint information transmitted from the paper fingerprint information acquisition unit 507 to the RAM 302, assigns an ID that is uniquely manageable in the apparatus to the paper fingerprint information, and writes the ID as a paper fingerprint information ID into the related table.

At step S1203, the paper fingerprint information management unit 340 holds the related table written at steps S1201 and S1202 in the RAM 302.

[Description of a Related Table 1301 (FIG. 13)]

Description will now be given with reference to FIG. 13 with regard to an example of the above-mentioned related table.

By the paper fingerprint information collation process described with reference to FIG. 9, the CPU 301 performs a process for comparing between paper fingerprint information (or paper fingerprint information for collation) of a read original and paper fingerprint information (or paper fingerprint information to be collated) managed in the RAM 302 by the paper fingerprint information management unit 340. If the result of the comparison process indicates a “match”, the CPU 301 reads out information from the related table 1301 held in the RAM 302, which stores related information “page number—image data ID—paper fingerprint data ID”. After that, the CPU 301 determines related image data 1303 and a related page number 1304 from the matched paper fingerprint information.

This will be described for example with reference to FIG. 13. If paper fingerprint information 1302-1 is judged as a “match”, the CPU 301 derives image data 1303-1 from the image data ID corresponding to a row containing the paper fingerprint data ID “1” (or the ID corresponding to the paper fingerprint information 1302-1) in the related table 1301. The CPU 301 can further derive the page number “1” corresponding to the row containing the paper fingerprint data ID “1” in the related table 1301.

Although the description is herein given taking an instance where the configuration is such that the related table 1301, the paper fingerprint information 1302, the image data 1303 and the page number 1304 are held in the RAM 302, the configuration may be such that they are temporarily stored on the HDD 304 and are then read into the RAM 302.

[Detailed Description of the Print Settings (That is, Interleaving Settings) (FIG. 10)

Description will now be given with reference to FIG. 10 with regard to an interleaving setting screen for doing printing while inserting interleaving paper during print execution.

FIG. 10 shows the screen that appears when an interleaving setting key is pressed down on a print setting select screen (not shown) after the press of the custom mode key 718 on the copy standard screen on the operation panel shown in FIG. 7. The interleaving settings refer to the function of inserting sheet (e.g., colored paper) placed in anyone of the paper cassettes (e.g., the paper cassette 203) between sheets of printing paper outputted by the image forming apparatus 10. Description will be given below with regard to various settings for interleaving.

Reference numeral 1001 denotes a key for selecting the paper cassette that feeds the sheet to be inserted as the interleaving paper. At the press of the key 1001, a paper cassette select screen (not shown) appears so that any given paper cassette becomes selectable.

Reference numeral 1002 denotes a group of keys for doing specified printing on paper used as the interleaving paper. The keys 1002 can be used for settings to perform printing (that is, single-sided or double-sided printing) on the interleaving paper or perform no printing thereon.

Reference numeral 1003 denotes a cancel key, which is used to return to the copy standard screen shown in FIG. 7 so as not to do the interleaving settings on the screen shown in FIG. 10.

Reference numeral 1004 denotes a key for acquiring paper fingerprint information from a paper document in order to determine where the interleaving paper should be inserted in an original. Specifically, the press of the key 1004 leads to the reading of an original and enables doing various settings as to paper fingerprint information of the read original. This paper fingerprint information reading process is the same as the entry operation for paper fingerprint information to be collated at the press of the paper fingerprint information entry tab 720, described with reference to FIG. 16.

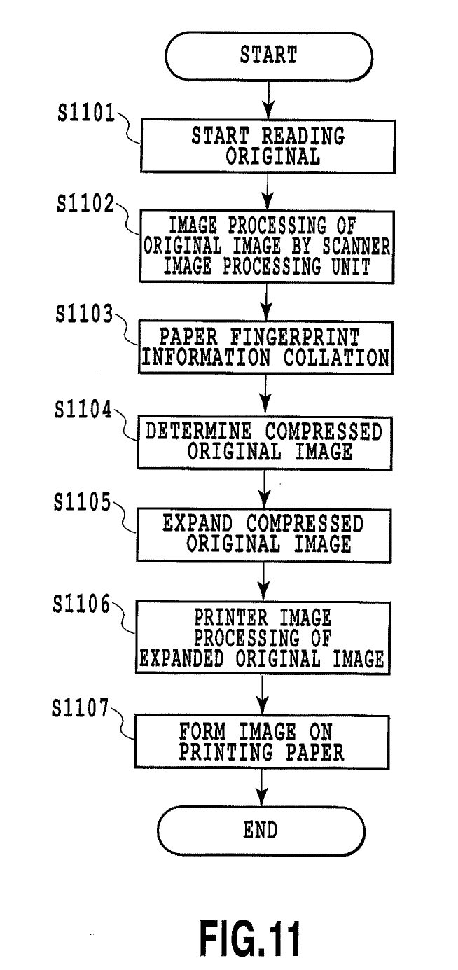

Moreover, the embodiment not only implements the above-mentioned interleaving setting function but also may implement other print settings.

[Operation at the Press of the Paper Fingerprint Information Reading Key 1004 (FIG. 11)

Description will now be given with reference to FIG. 11 with regard to the process that is executed when the start key (not shown) is pressed down after the entry of paper fingerprint information by the user's press of the paper fingerprint information reading key 1004 shown in FIG. 10.

At step S1101, the CPU 301 performs control so that image data on an original read by the scanner unit 13 is transmitted to the scanner image processing unit 312 via the scanner I/F 311.

At step S1102, the scanner image processing unit 312 processes the image data using the processing described above with reference to FIG. 5. The paper fingerprint information acquisition unit 507 in the scanner image processing unit 312 acquires paper fingerprint information (incidentally, the configuration in which the gain control by the shading correction unit 500 and the like are performed in order to acquire the paper fingerprint information is as mentioned above). Then, the scanner image processing unit 312 transmits the acquired paper fingerprint information to the RAM 302 via the data bus (not shown).

At step S1103, the CPU301 performs the paper fingerprint information collation process, as described in the section “[A paper fingerprint information collation process (FIG. 9)]”.

When the result of step S1103 (a “match” or “mismatch”) shows the “match”, at step S1104 the CPU 301 determines image data stored in the RAM 302, which is associated with the matched paper fingerprint information by the paper fingerprint information management unit 340.

This image data determining process is as described with reference to FIG. 13. At this step, the CPU 301 further associates print attribute data (e.g., the insertion of interleaving paper prior to output of the image data, etc.) for the determined image data with the image data. The print attribute data is inputted on the operation panel shown in FIG. 10, and besides the interleaving settings, various print settings can be made as mentioned above.

At step S1105, the CPU 301 performs control so that image data stored in the RAM 302 is transmitted to the expansion unit 316. At step S1105, moreover, the expansion unit 316 expands the image data. Furthermore, the expansion unit 316 rasterizes the expanded image data composed of plural tile image data and transmits the rasterized image data to the printer image processing unit 315.

At step S1106, the printer image processing unit 315 performs an image data editing process according to attribute data associated with the image data, as shown in FIG. 6. At step S1106, the printer image processing unit 315 also performs print control according to the print attribute data produced at step S1104.

Then, at step S1106, the halftone correction unit 606 shown in FIG. 6 performs the halftone process on the image data in accordance with the number of levels of gray of the printer unit 14 that produces output. The printer image processing unit 315 transmits the halftone-processed image data to the printer unit 14 via the printer I/F 314.

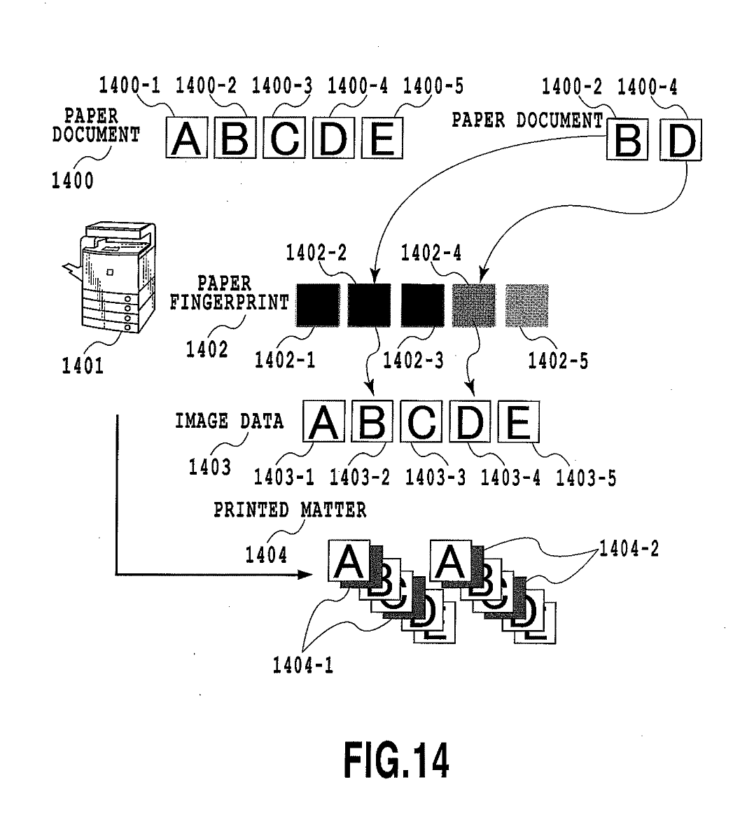

41 Finally, at step S1107, the printer unit 14 performs the print process utilizing the print attribute data attached at step S1104, to thereby form the image data into an image on printing paper.

[A General View of the Overall Process Under Interleaving Setting Conditions (FIG. 14)]

Description will now be given with reference to FIG. 14 with regard to the general view of the overall process under conditions of the interleaving settings shown in FIG. 10.

First, paper documents 1400 for print are placed in the scanner unit 13 of an image forming apparatus 1401, and the paper fingerprint information reading key 1004 shown in FIG. 10 is pressed down to thereby execute the entry of paper fingerprint information. By the process described with reference to FIG. 16, the CPU 301 performs control so that the RAM 302 of the image forming apparatus 1401 stores paper fingerprint information 1402 and image data 1403 in conjunction with corresponding page numbers.

By the process described with reference to FIG. 12, the paper fingerprint information management unit 340 stores the related table 1301 containing the paper fingerprint information 1402, the image data 1403 and the corresponding page numbers in correlation with one another, in the RAM 302 of the image forming apparatus 1401.

By the process described with reference to FIG. 11, all pages of the paper documents between which interleaving paper is to be inserted are placed in the scanner unit 13, and the paper fingerprint information reading process is executed. Then, the CPU 301 compares the paper fingerprint information 1402 managed in the RAM 302 by the paper fingerprint information management unit 340 with paper fingerprints of the read paper documents. The comparison process is as described for the process of FIG. 9.

FIG. 14 shows an instance where the interleaving paper is inserted between the paper documents 1400. The description is herein given, provided that settings are made on the operation panel shown in FIG. 10 so that sheets of interleaving paper are inserted before paper documents 1400-2 and 1400-4.

FIG. 14 shows that, as the result of the comparison process, a paper fingerprint 1402-2 is determined from the paper document 1400-2 and a paper fingerprint 1402-4 is determined from the paper document 1400-4.

By the process described with reference to FIG. 13, image data corresponding to the paper fingerprints are determined from the related table 1301 managed in the RAM 302 by the paper fingerprint information management unit 340. Referring for example to FIG. 14, image data 1403-2 is determined from the paper fingerprint 1402-2 and image data 1403-4 is determined from the paper fingerprint 1402-4.

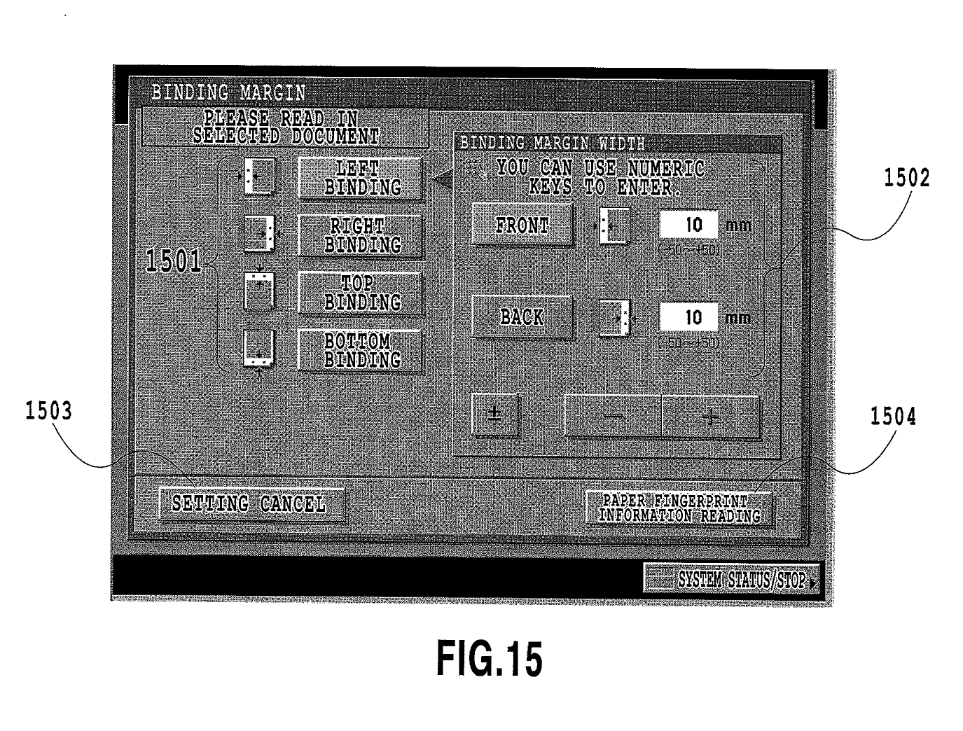

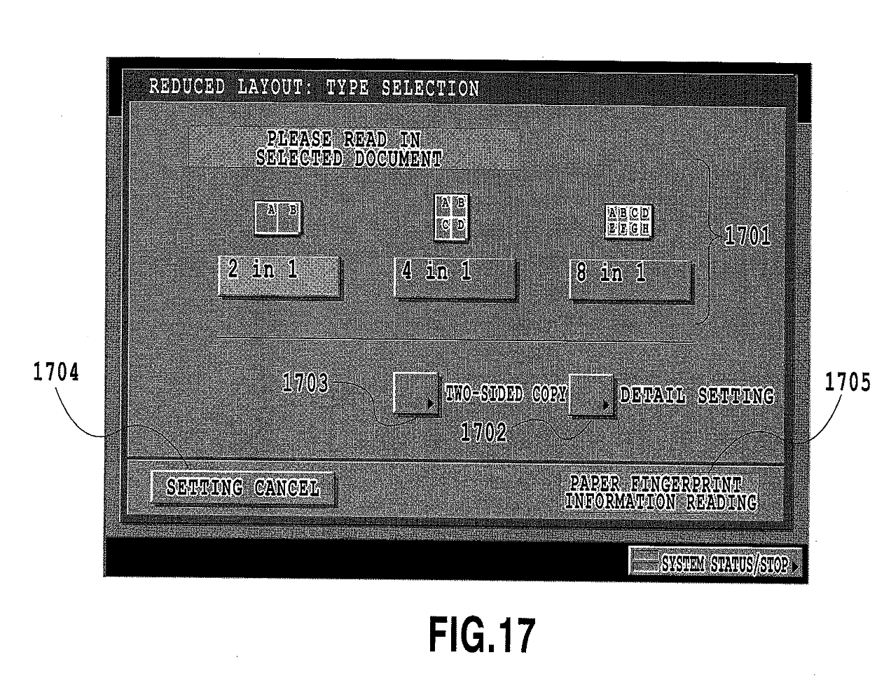

Then, the printer unit 14 forms the image data into an image on printing paper and also does print settings according to print attribute data associated with the determined image data to thereby produce printed matter 1404, as in the case of the process described with reference to step S1104 of FIG. 11. In the instance shown in FIG. 14, sheets of interleaving paper (1404-1 and 1404-2) are inserted in the positions of the determined image data so that two copies of printed matter are produced. Although the description has been given with regard to the embodiment in which the interleaving paper is inserted before output of the determined image data, an embodiment may be such that the interleaving paper is inserted after output of the determined image data.

[Detailed Description of Other Print Settings (FIGS. 15 and 17)]

Description will be given with reference to FIGS. 15 and 17 with regard to operating screens in the configuration of the present invention as adapted for different print settings from the interleaving settings described with reference to FIG. 10.

FIG. 15 shows the operating screen for doing print settings for binding margin settings.

FIG. 15 shows the screen that appears when a binding margin setting key is pressed down on the print setting select screen (not shown) after the press of the custom mode key 718 on the copy standard screen on the operation panel shown in FIG. 7. The binding margin setting refers to the function of forming margins for binding by shifting an image by specified amounts in specified directions at the top, bottom, right and left of printing paper.

Reference numeral 1501 denotes a group of keys for specifying binding directions. FIG. 15 illustrates a situation where “left binding” is specified.

Reference numeral 1502 denotes a group of keys for setting binding margin widths. Different values can be set on the front and back of paper when double-sided print mode is selected (or when the two-sided copy key 711 shown in FIG. 7 is pressed down).

Reference numeral 1503 denotes a setting cancel key, which is used to return to the copy standard screen shown in FIG. 7 so as not to do the binding margin setting on the screen shown in FIG. 15.

A paper fingerprint information reading key 1504 is used to read a paper document by the scanner unit 13 and acquire paper fingerprint information. The paper fingerprint information reading key 1504 is used to specify a document which print settings are made with the keys 1501 and 1502 as an object for paper fingerprint reading. An operation that is performed when the start key (not shown) is pressed down after the entry of paper fingerprint information by the press of the paper fingerprint information reading key 1504 is the same as the process described with reference to FIG. 11.

FIG. 17 shows the operating screen for doing print settings for reduced layout settings.

FIG. 17 shows the screen that appears when a reduced layout setting key is pressed down on the print setting select screen (not shown) after the press of the custom mode key 718 on the copy standard screen on the operation panel shown in FIG. 7.

The reduced layout setting refers to the function of doing layout copying so that N documents fit in a sheet of paper.

Reference numeral 1701 denotes a group of keys for selecting from among layout settings: “2 in 1,” “4 in 1,” and “8 in 1”. In this instance, the layout setting “2 in 1” is selected, and thus, layout is designed for copying so that two documents fit in a sheet of paper.

Reference numeral 1702 denotes a detail setting key. When the key 1702 is pressed down, a transition to another screen (not shown) can be made to set layout order.

Reference numeral 1703 denotes a two-sided copy select key, which is used to do two-sided copying.

Reference numeral 1704 denotes a setting cancel key, which is used to return to the copy standard screen shown in FIG. 7 so as not to do the reduced layout setting on the screen shown in FIG. 17.

A paper fingerprint information reading key 1705 is used to read a paper document by the scanner unit 13 and thereby acquire paper fingerprint information. The paper fingerprint information reading key 1705 is used to specify a document which print settings are made with the keys 1701, 1702 and 1703 as an object for paper fingerprint reading. An operation that is performed when the start key (not shown) is pressed down after the entry of paper fingerprint information by the press of the paper fingerprint information reading key 1705 is the same as the process described with reference to FIG. 11.

### Another Embodiment 1

Description will be given with reference to another embodiment 1 with regard to an instance where there is provided a different scanner unit (not shown) from the scanner unit 13 according to the above-mentioned embodiment.

The different scanner unit is assumed to be physically configured in a place where it can acquire paper fingerprint information of paper fed from the paper cassette (e.g., the paper cassette 203) of the image forming apparatus 10.

The different scanner unit is also configured to connect to the controller unit 11 that controls operation over the image forming apparatus 10, as in the case of the scanner unit 13 shown in FIG. 1.

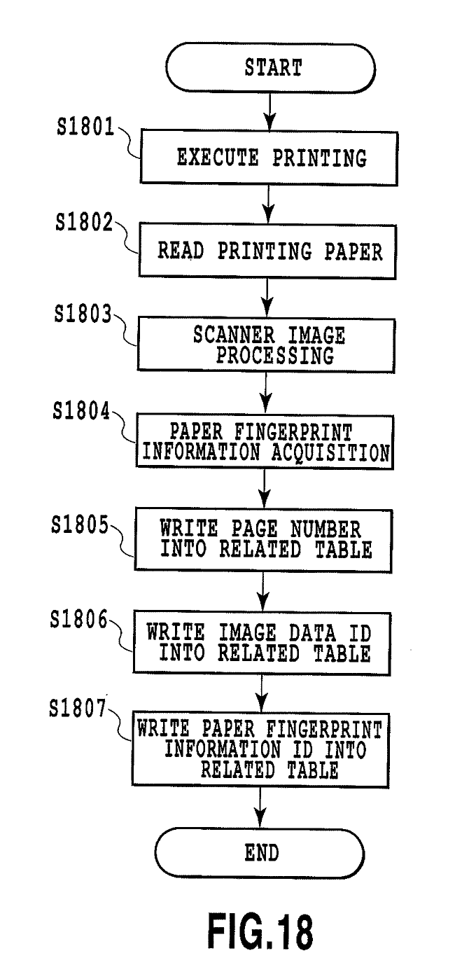

Description will now be given with reference to FIG. 18 with regard to the flow of processing that takes place when the different scanner unit acquires paper fingerprint information and the paper fingerprint information management unit 340 enters the acquired paper fingerprint information.

At step S1801, the CPU 301 retrieves image data stored in the RAM 302 or on the HDD 304 and transmits the image data to the printer image processing unit 315. The printer image processing unit 315 transmits the image data via the printer I/F 314 to the printer unit 14, which in turn executes the print process on the image data.

At step S1802, the different scanner unit performs a process for reading printing paper fed from the paper cassette 203 during print execution.

At step S1803, the shading correction unit 500 sets a smaller gain control value than a gain control value for general reading, and then the scanner image processing unit 312 performs scanner image processing and performs the paper reading process.

At step S1804, the paper fingerprint information acquisition unit 507 acquires paper fingerprint information from the image data read at step S1803.

At step S1805, the CPU 301 writes page number information assigned in the order in which the image data is retrieved at step S1801, into the related table 1301 managed in the RAM 302, which stores related information “page number—image data—paper fingerprint information”.

At step S1806, the CPU 301 acquires ID information assigned to image data held in the RAM 302 or on the HDD 304, and writes the ID information as a related image data ID into the related table 1301 written at step S1805.

At step S1807, an ID that is uniquely manageable in the apparatus is assigned to the paper fingerprint information acquired at step S1804, and is written as a related paper fingerprint information ID into the related table 1301 written at steps S1805 and S1806.

The paper fingerprint information management unit 340 manages the related table 1301 registered through the above steps. Thus, when paper fingerprint information is determined, the paper fingerprint information management unit 340 determines image data and a page number related to the paper fingerprint information.

The paper fingerprint information collation process, the setting method for the print settings, and the details of processing therefor, except for the above, are the same as those of the above-mentioned embodiment for carrying out the present invention.

The another embodiment 1 facilitates changing print settings, utilizing a paper fingerprint of a paper document, even if a paper document for printing is absent and an object to be printed is held in advance as image data in the RAM 302 or the HDD 304 of the image forming apparatus 10.

### Another Embodiment 2

The above description has been given with regard to the embodiment in which the print settings are made by the operation unit 12 of the image forming apparatus, which serves as the user interface. However, the print settings may be made by the PC 40 or the like via the LAN 50 or the WAN 331. Specifically, the present invention also enables doing various print settings, utilizing paper fingerprint information previously read by the image forming apparatus 10.

### Another Embodiment 3

Furthermore, the present invention may be applied to a system configured of plural devices (for example, a computer, an interface device, a reader, a printer, and so on), or an apparatus formed of one device (such as a combined machine, a printer, or a facsimile).

To achieve the object of the present invention, a program that implements the procedures of the flowcharts described with reference to the above embodiments may be read into execution from a storage medium having the program stored thereon, by the computer (or the CPU or an MPU (microprocessor unit)) of the system or the apparatus. In this case, the program in itself read from the storage medium implements the functions of the embodiments mentioned above. Thus, the program and the storage medium having the program stored thereon are also included in the present invention.

For example, a floppy disk (the word “floppy” is a registered trademark), a hard disk, an optical disc, a magneto-optical disk, a CD-ROM, a CD-R, a magnetic tape, a nonvolatile memory card, ROM, or the like can be used as the storage medium for supplying the program.

The program read by the computer is executed to thereby implement the functions of the embodiments mentioned above. In addition, actual processing may be partially or wholly performed by an OS (operating system) or the like running on the computer under commands from the program to thereby implement the functions of the embodiments mentioned above.

Furthermore, the program read from the storage medium may be written into memory provided for a feature expansion board inserted in the computer or a feature expansion unit connected to the computer. Then, actual processing may be partially or wholly performed by a CPU or the like provided for the feature expansion board or the feature expansion unit under commands from the program to thereby implement the functions of the embodiments mentioned above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-328523, filed Dec. 5, 2006, which is hereby incorporated by reference herein in its entirety.

What is claimed is:

1. An image forming apparatus, comprising:
first storage means that stores first fiber information in one or more places on a first image recording medium;
second storage means that stores second fiber information in one or more places on a second image recording medium;
related information storage means that reads the first fiber information and stores related information in which image information and page order corresponding to the first fiber information are related to each other;
comparing means that compares the first fiber information with the second fiber information with each other, by use of the related information stored in the related information storage means, and thereby determines whether or not the first fiber information and the second fiber information match with each other; and
image forming means that determines, by using the related information, the image information to be performed print settings inputted to the image forming apparatus, performs the print settings on the determined image information, and performs image forming processing, when the comparing means determines that the first fiber information and the second fiber information match with each other.

2. The image forming apparatus according to claim 1, wherein the first storage means and the second storage means are the same storage means.

3. The image forming apparatus according to claim 1, further comprising input means for inputting the print settings.

4. The image forming apparatus according to claim 3, wherein the input means is any one of means for inputting the print settings transmitted from a different apparatus to the image forming apparatus, and operating means that is operable by a user.

5. An image forming method with which an image forming apparatus forms an image, comprising the steps of:
storing first fiber information in one or more places on a first image recording medium in first storage means;
reading the first fiber information and storing related information in related information storage means, the related information containing image information and page order corresponding to the first fiber information and being related to each other;
storing second fiber information in one or more places on a second image recording medium in second storage means;
determining whether or not first fiber information and the second fiber information match with each other, by comparing the first fiber information with the second fiber information, by using the related information stored in the related information storage means; and
determining, by using the related information, the image information to be performed print setting inputted to the image forming apparatus, performing the print settings on the determined image information, and forming the image, when the comparing means determines that the first fiber information and the second fiber information match with each other.

6. The image forming method according to claim 5, further comprising the step of performing the print settings page by page by using the related information stored in the related information storage means.

7. The image forming method according to claim 5, further comprising the step of inputting the print settings.

8. A program making a computer to execute the steps according to any one of claims 5 to 7.

9. A computer-readable storage medium storing the program according to claim 8.

10. An image processing apparatus, comprising:
printing medium characteristic storage means that stores, as characteristic data, fiber information in one or more places on an image recording medium;
means that stores image data to be printed on the image recording medium;
related information recording means that stores the characteristic data of the image recording medium and the image data to be printed on the image recording medium in association with each other,
reading means that reads the image recording medium;
means that reads the characteristic data of the fiber information on the image recording medium by the reading means, and determines the associated image data from the characteristic data by the related information recording means; and
means that performs a set print process on the determined image data.

11. The image processing apparatus according to claim 10, wherein the fiber information in one or more places on one or plural image recording media is read by the reading means, and is stored by the printing medium characteristic storage means.
